(19) United States
(12) Patent Application Publication
(10) Pub. No.: US 2008/0129602 A1
(43) Pub. Date: Jun. 5, 2008

(54) PLANAR ANTENNA

(75) Inventors: Xiang-Hong Qin, Shenzhen (CN); Jia-Lin Teng, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/625,289

(22) Filed: Jan. 20, 2007

(30) Foreign Application Priority Data
Dec. 1, 2006 (TW) 95144722

(51) Int. Cl. H01Q 1/38

(52) U.S. Cl. 343/700 MS

(57) ABSTRACT

A planar antenna disposed on a substrate (50) including a first surface (57) and a second surface (58). The planar antenna includes a radiating body (10) for transmitting and receiving radio frequency (RF) signals, a feeding portion (30) for feeding signals, and a metallic ground plane (50). The radiating body includes an angled gap (15) formed therein. The feeding portion is electrically connected to the radiating body. The radiating body and the feeding portion are laid on the first surface of the substrate. The ground plane is laid on the second surface of the substrate.

### BACKGROUND OF THE INVENTION

1. Field of the Invention

The invention relates to planar antennas, and particularly to a planar antenna for use in ultra-wideband (UWB) communication systems.

2. Description of Related Art

A frequency band of an ultra-wideband (UWB) wireless communication system is 3.1-10.6 GHz. In a wireless communication system, the antenna is a key element for radiating and receiving radio frequency signals. Therefore, an operating frequency band of the antenna must be 3.1-10.6 GHz or greater.

### SUMMARY OF THE INVENTION

An exemplary embodiment of the present invention provides a planar antenna disposed on a substrate including a first surface and a second surface. The planar antenna includes a radiating body for transmitting and receiving radio frequency (RF) signals, a feeding portion for feeding signals, and a metallic ground plane. The radiating body includes an angled gap formed therein. The feeding portion is electrically connected to the radiating body. The radiating body and the feeding portion are laid on the first surface of the substrate. The ground plane is laid on the second surface of the substrate.

Other advantages and novel features will become more apparent from the following detailed description when taken in conjunction with the accompanying drawings, in which:

### BRIEF DESCRIPTION OF THE DRAWINGS

FIG. 1 is a schematic plan view of a planar antenna of an exemplary embodiment of the present invention;

FIG. 2 is similar to FIG. 1, but viewed from another aspect;

FIG. 3 is a schematic plan view illustrating dimensions of the planar antenna of FIG. 1;

FIG. 4 is a schematic plan view illustrating dimensions of the planar antenna of FIG. 2;

FIG. 5 is a graph of test results showing a voltage standing wave ratio (VSWR) of the planar antenna of FIG. 1;

FIG. 6 is a graph of test results showing a radiation pattern when the planar antenna of FIG. 1 is operated at 3.1 GHz;

FIG. 7 is a graph of test results showing a radiation pattern when the planar antenna of FIG. 1 is operated at 7.0 GHz; and

FIG. 8 is a graph of test results showing a radiation pattern when the planar antenna of FIG. 1 is operated at 10.6 GHz.

### DETAILED DESCRIPTION OF THE INVENTION

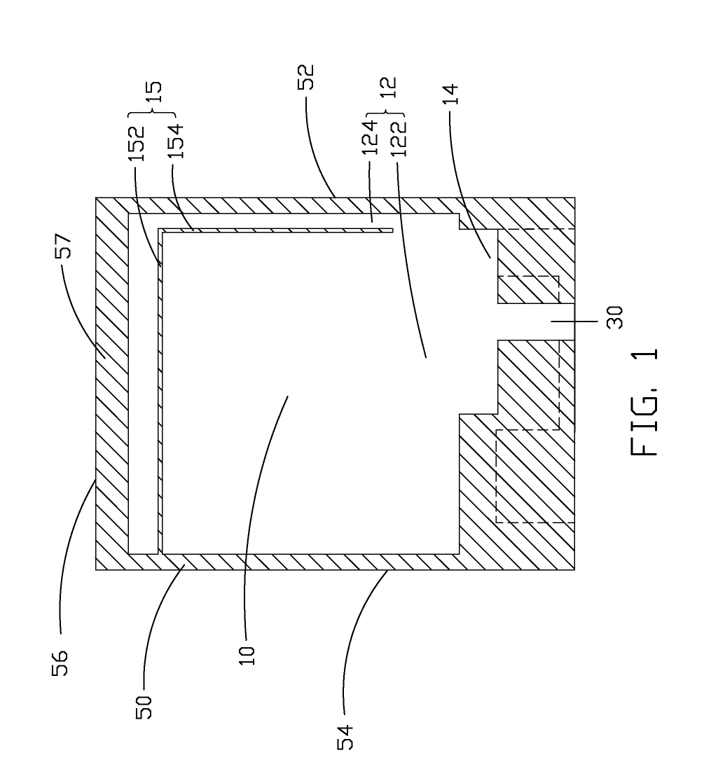

FIG. 1 is a schematic plan view of a planar antenna of an exemplary embodiment of the present invention. In the exemplary embodiment, the planar antenna is printed on a substrate 50.

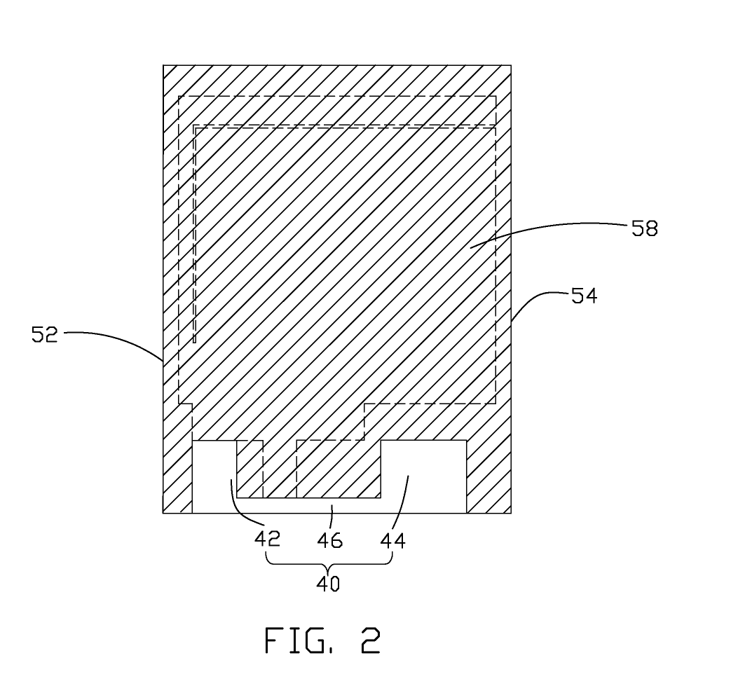

Referring also to FIG. 2, the substrate 50 comprises a first surface 57, a second surface 58 parallel to the first surface 57, a first side 52, a second side 54 parallel to the first side 52, and a third side 56 perpendicular to the first side 52.

The planar antenna comprises a radiating body 10, a metallic ground plane 40, and a feeding portion 30. The radiating body 10 and the feeding portion 30 are printed on the first surface 57. The ground plane 40 is printed on the second surface 58.

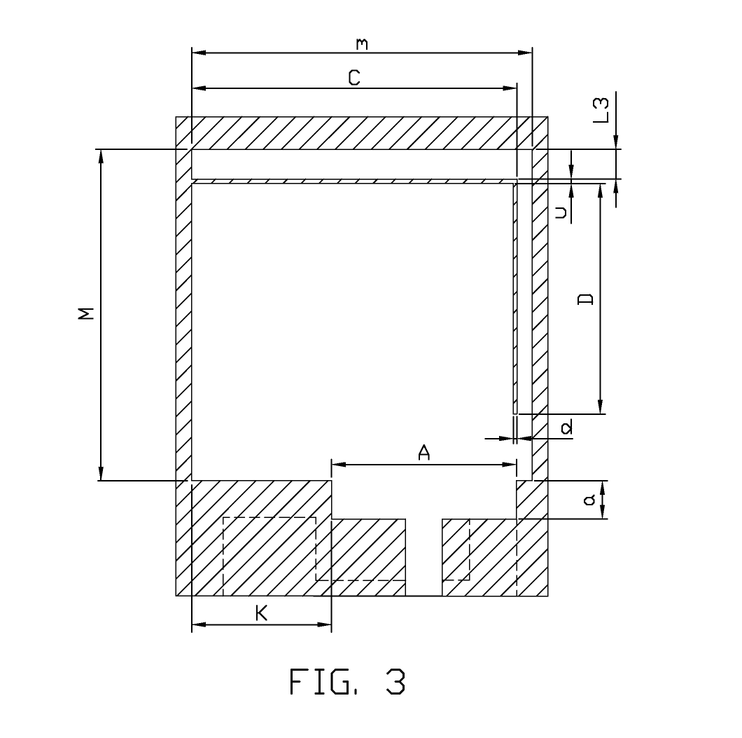

The radiating body 10 transmits and receives radio frequency (RF) signals. The radiating body 10 comprises a main body 12 and a connecting portion 14 electrically connecting the main body 12 and the feeding portion 30. A length of the connecting portion 14 along a connecting side of the radiating body 10 with the connecting portion 14 is smaller than a width of the radiating body 10 along the same connecting side of the radiating body 10 (See below descriptions of FIG. 3 for more details). An L-shaped gap 15 is formed in the main body 12, thereby the main body 12 is divided into a first radiating portion 122 and a second radiating portion 124. The second radiating portion 124 partly surrounds the first radiating portion 122. The connecting portion 14 electrically connects the first radiating portion 122 and the feeding portion 30. The gap 15 comprises a first portion 152, and a second portion 154 perpendicularly communicating with the first portion 152. The first portion 152 extends from a side of the main body 12 adjacent to the second side 54 of the substrate 50 terminating near an opposite side of the main body 12 adjacent to the first side 52 of the substrate 50. The second portion 154 extends from a distal end of the first portion 152 terminating near the connecting portion 14. In alternative embodiments, the gap 15 may form other angled shapes besides an L, such as a W-shape, a C-shape, and so on. The connecting portion 14 is defined as a part of the first radiating portion 122.

The feeding portion 30 is electrically connected to and feeds signals to the radiating portion 10. The feeding portion 30 is generally parallel to the second side 54 of the substrate 50, and is a 50Ω transmission line.

The ground plane 40 comprises a rectangular first ground portion 42, a rectangular second ground portion 44, and a rectangular third ground portion 46 connecting the first ground portion 42 with the second ground portion 44.

In the exemplary embodiment, an operating frequency band of the first radiating portion 122 overlaps an operating frequency band of the second radiating portion 124, thereby bandwidth of the planar antenna is increased.

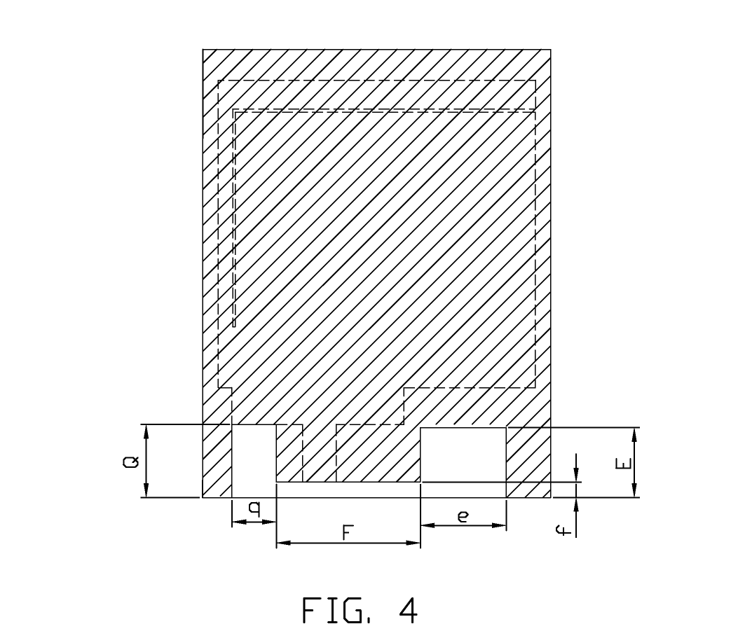

FIGS. 3 and 4 are schematic plan views illustrating dimensions of the planar antenna of FIG. 1. In the exemplary embodiment, a length M of the main body 12 is generally 10.75 mm, and a width m of the main body 12 is generally 11.0 mm. A length A, of the connecting portion 14 is generally 6.0 mm, and a width a, of the connecting portion 14 is generally 11.0 mm. A distance K between the connecting portion 14 and the side of the main body 12 adjacent to the second side 54 of the substrate 50 is generally 4.5 mm. A distance L3 between the first portion 152 of the gap 15 and a side of the main body 12 adjacent to the third side 56 of the substrate 50 is generally 1.0 mm. A length C of the first portion 152 of the gap 15 is generally 10.5 mm, and a width c of the first portion 152 is generally 0.1 mm. A length D of the second portion 154 of the gap 15 is generally 7.5 mm, and a width d of the second portion 154 is generally 0.1 mm. A length Q of the first ground portion 42 is generally 2.5 mm, and a width q of the first ground portion 42 is generally 1.5 mm. A length E of the second ground portion 44 is generally 3.0 mm, and a width e of the second ground portion 44 is generally 2.5 mm. A length F of the third ground portion 46 is generally 5.0 mm, and a width f of the third ground portion 46 is generally 0.5 mm.

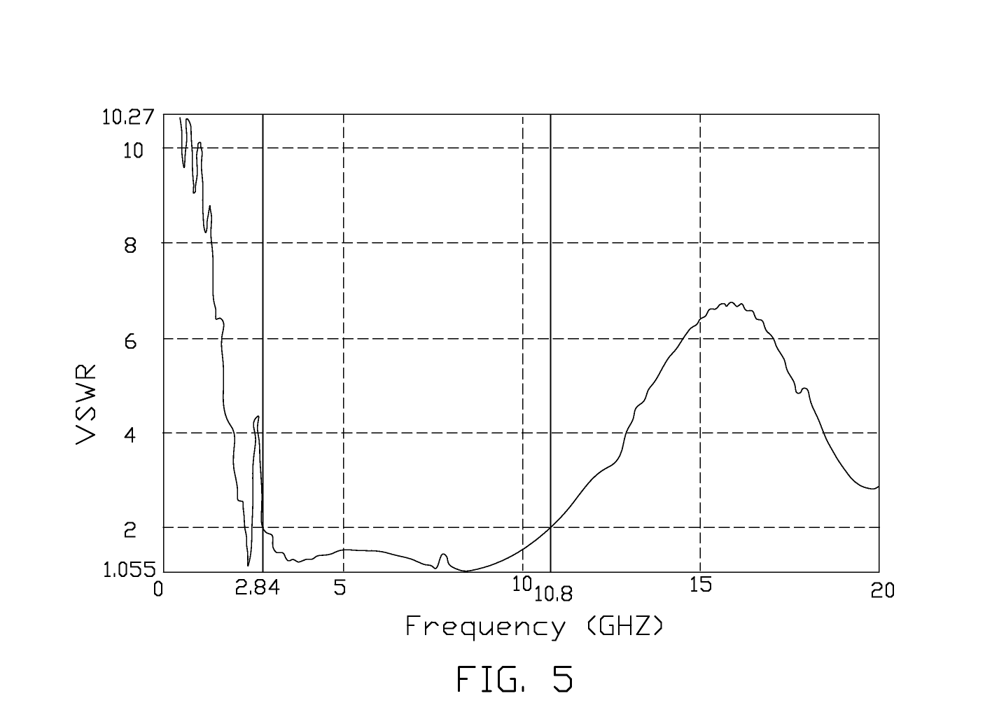

FIG. 5 is a graph of test results showing voltage standing wave ratios (VSWR) at UWB frequencies, of the planar antenna. A horizontal axis represents the frequency (in GHz) of the electromagnetic signals traveling through the planar antenna, and a vertical axis represents VSWR. VSWR of the planar antenna over the UWB range of frequencies is indicated by a curve. As shown in FIG. 4, the planar antenna has a good performance when operating at frequencies from 3.1-10.6 GHz. The amplitudes of the VSWRs in the band pass frequency range are less than 2, which is what is required for an antenna used in UWB systems.

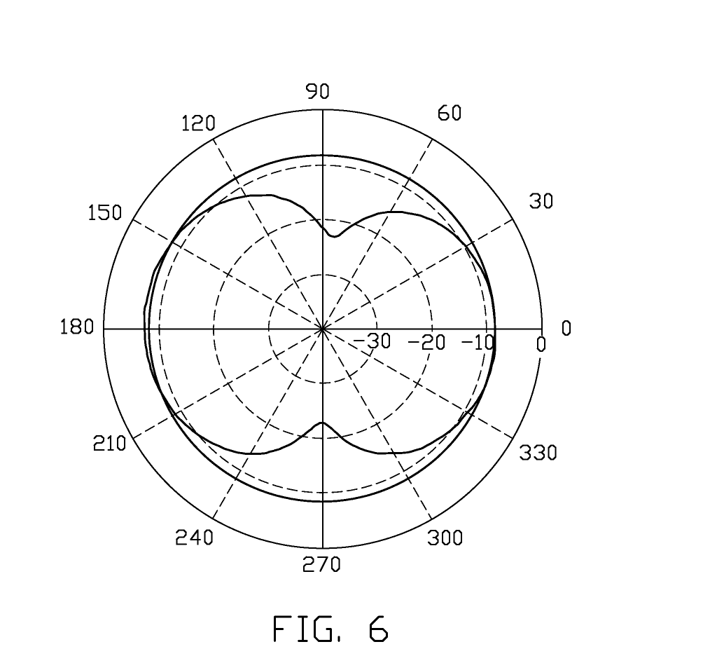

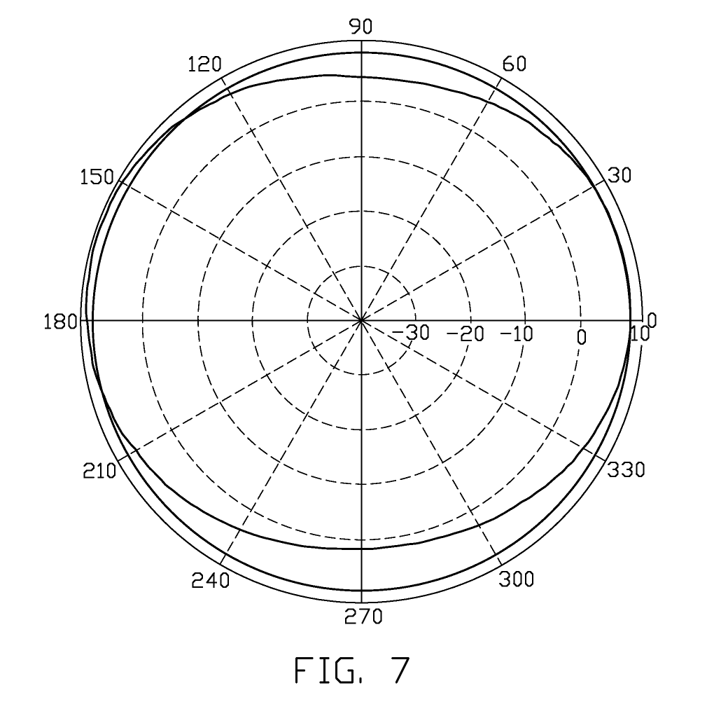

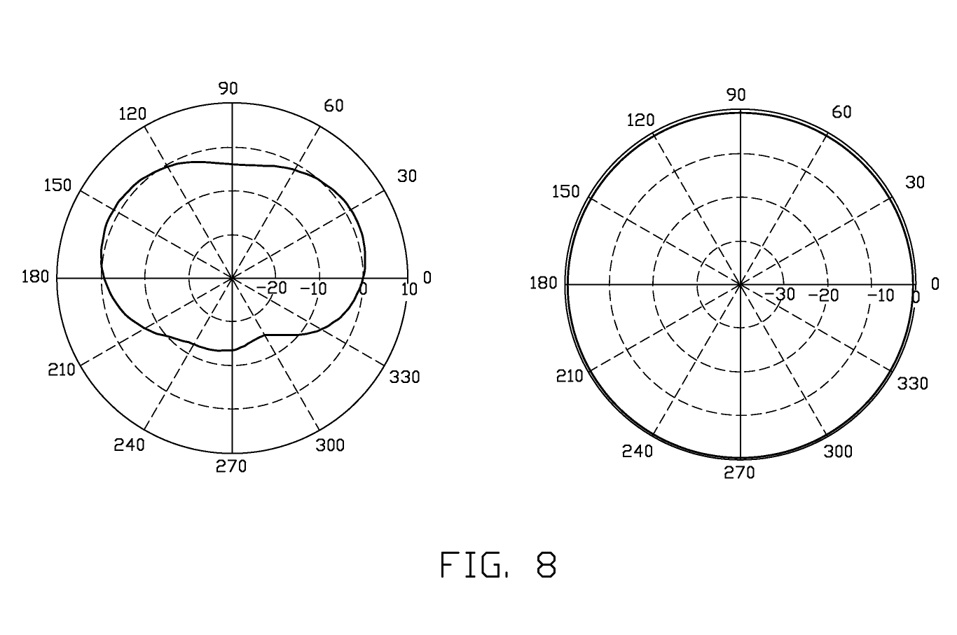

FIGS. 6-8 are graphs of test results showing radiation patterns when the planar antenna of FIG. 1 is operated at 3.1 GHz, 7.0 GHz, and 10.6 GHz, respectively. As seen, all of the radiation patterns are substantially omni-directional.

While embodiments of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A planar antenna printed on a substrate comprising a first surface and a second surface, the planar antenna comprising:
a radiating body for transmitting and receiving radio frequency (RF) signals, the radiating body comprising an angled gap formed therein;
a feeding portion for feeding signals, the feeding portion electrically connected to the radiating body; and
a metallic ground plane;
wherein the radiating body and the feeding portion are laid on the first surface of the substrate, and the ground plane is laid on the second surface of the substrate.

2. The planar antenna as claimed in claim 1, wherein an operating frequency band of the planar antenna is 3.1-10.6 GHz.

3. The planar antenna as claimed in claim 1, wherein the gap is L-shaped.

4. The planar antenna as claimed in claim 3, wherein the gap comprises a first portion and a second portion perpendicularly communicating with the first portion.

5. The planar antenna as claimed in claim 4, wherein the first portion of the gap is spatially communicable with an outside of the radiating body at a first side of the radiating body different from a second side of the radiating body used to electrically connect with the feeding portion.

6. The planar antenna as claimed in claim 5, wherein a connecting portion is electrically connectable between the radiating body and the feeding portion, and a length of the connecting portion along the second side of the radiating body is smaller than a width of the radiating body along the second side thereof.

7. The planar antenna as claimed in claim 1, wherein the ground plane comprises a rectangular first ground portion, a rectangular second ground portion, and a rectangular third ground portion connecting the first ground portion with the second ground portion.

8. An ultra-wideband (UWB) antenna disposed on a substrate comprising a first surface and a second surface, the UWB antenna comprising:
a radiating body for transmitting and receiving radio frequency (RF) signals, the radiating body comprising a gap formed therein;
a feeding portion for feeding signals, the feeding portion electrically connected to the radiating body; and
a metallic ground plane;
wherein the radiating body and the feeding portion are laid on the first surface of the substrate, and the ground plane is laid on the second surface of the substrate.

9. The UWB antenna as claimed in claim 8, wherein the gap has an angled shape.

10. The UWB antenna as claimed in claim 9, wherein the gap is L-shaped.

11. The UWB antenna as claimed in claim 10, wherein the gap comprises a first portion and a second portion perpendicularly communicating with the first portion.

12. The UWB antenna as claimed in claim 11, wherein the first portion of the gap is spatially communicable with an outside of the radiating body at a first side of the radiating body different from a second side of the radiating body used to electrically connect with the feeding portion.

13. The UWB antenna as claimed in claim 12, wherein a connecting portion is electrically connectable between the radiating body and the feeding portion, and a length of the connecting portion along the second side of the radiating body is smaller than a width of the radiating body along the second side thereof.

14. The UWB antenna as claimed in claim 8, wherein the ground plane comprises a rectangular first ground portion, a rectangular second ground portion, and a rectangular third ground portion connecting the first ground portion with the second ground portion.

15. An antenna assembly comprising:
a substrate; and
an antenna disposed on said substrate, comprising a radiating body formed on a surface of said substrate for transmitting and receiving radio frequency (RF) signals, and a feeding portion electrically connectable with said radiating body for feeding said RF signals, a gap formed in said radiating body comprising a straightly extending first portion and a straightly extending second portion, said first portion and said second portion angularly intersecting and spatially communicable with each other inside said radiating body so as to divide said radiating body into at least two radiating portions together.

16. The antenna assembly as claimed in claim 15, wherein said gap is spatially communicable with an outside of said radiating body at a first side of said radiating body different from a second side of said radiating body used to electrically connect with said feeding portion.

17. The antenna assembly as claimed in claim 16, wherein a connecting portion is electrically connectable between said radiating body and said feeding portion, and a length of said connecting portion along said second side of said radiating body is smaller than a width of said radiating body along said second side thereof.

18. The antenna assembly as claimed in claim 15, wherein a metallic ground plane of said antenna is disposed on another surface of said substrate opposite to said surface on which said radiating body of said antenna is disposed.
